(19) United States
(12) Patent Application Publication
(10) Pub. No.: US 2025/0277400 A1
(43) Pub. Date: Sep. 4, 2025

(54) METHOD AND SYSTEM FOR SELECTIVELY ACTUATING AN AUTOMATIC DOOR OF A MOTOR VEHICLE FOR PASSENGER INGRESS OR EGRESS

(71) Applicants: HYUNDAI MOTOR COMPANY, Seoul (KR); KIA CORPORATION, Seoul (KR)

(72) Inventors: Sebastian Klüh, Gimbsheim (DE); Michael Schreiber, Frankfurt am Main (DE)

(73) Assignees: HYUNDAI MOTOR COMPANY, Seoul (KR); KIA CORPORATION, Seoul (KR)

(21) Appl. No.: 18/891,547

(22) Filed: Sep. 20, 2024

(30) Foreign Application Priority Data
Feb. 29, 2024 (DE) 102024105786.6

(51) Int. Cl. E05F 15/73; E05F 15/71

(52) U.S. Cl. CPC E05F 15/73; E05F 15/71; E05Y 2900/531

(57) ABSTRACT

A method for selectively actuating an automatic door of a motor vehicle for passenger ingress or egress includes: determining, by a seat allocation unit of the motor vehicle, a seat occupied by a passenger within the motor vehicle; assessing, by a passenger control unit of the motor vehicle, that the passenger intends to egress the motor vehicle or that another passenger wants to ingress into the motor vehicle; determining, by an environmental sensor unit of the motor vehicle, current environmental conditions around the motor vehicle; selecting, by the passenger control unit and based on the determined seat and the determined current environmental conditions, an automatic door of the motor vehicle as an egress/ingress door for the passenger ingress or egress and specifying a door opening configuration for the egress/ingress door; and actuating, by a door control unit, the egress/ingress door based on the specified door opening configuration.

### TECHNICAL FIELD

The present disclosure pertains to a method and a system for selectively actuating an automatic door of a motor vehicle for passenger ingress or egress as well as to a motor vehicle with such a system.

### BACKGROUND

Carpooling (also called ride-pooling, car-sharing, ride-sharing and/or lift-sharing) is the sharing of car journeys such that more than one person travels in a car. By having more people using one vehicle, carpooling and similar concepts reduce each person's travel costs comprising fuel costs, tolls and the stress of driving. These concepts are also a more environmentally friendly and sustainable way to travel as sharing journeys reduces air pollution, carbon emissions, traffic congestion on the roads and the need for parking spaces. Car sharing is a progressive way to use up the full seating capacity of a car, which would otherwise remain unused if it were just the driver using the car.

Commercial pooling services have been introduced recently that pool several passengers together in one ride, e.g. by matching passengers with vehicles via websites or mobile applications. In these cases, each passenger has to be let out of the vehicle when the individual destination is reached. Often, automatic doors are provided that slide open automatically when one or several passengers intend to egress from the respective vehicle. This may inconveniently affect the other passengers remaining in the vehicle during bad weather or other adverse environmental conditions, because influences from the environment may reach these passengers through the opened doors more or less unhindered.

U.S. Pat. No. 10,384,519 B1 describes a door positioning system that moves the doors freely and fluidly relative to the body of the vehicle. The door positioning system controls the movement and positioning of each door using a door mechanism coupled between the door and the body of the vehicle and determines a position or path of motion for each door based on sensor data and user input. For example, the front door may slide open at an angle to accommodate an angled tire. Front and rear doors may open in opposite directions to create a large, unobstructed space for passengers to enter and exit the vehicle.

### DETAILED DESCRIPTION

In light of the above, there is a need to find solutions for automatic door actuation in motor vehicles with improved comfort and safety.

To this end, the present disclosure provides a method and system for selectively actuating an automatic door of a motor vehicle for passenger ingress or egress, and a motor vehicle in accordance with the same.

According to one aspect of the present disclosure, a method for selectively actuating an automatic door of a motor vehicle for passenger ingress or egress includes: determining, by a seat allocation unit of the motor vehicle, a seat occupied by a passenger within the motor vehicle; assessing, by a passenger control unit of the motor vehicle, that the passenger intends to egress the motor vehicle or that another passenger wants to ingress into the motor vehicle; determining, by an environmental sensor unit of the motor vehicle, current environmental conditions around the motor vehicle; selecting, by the passenger control unit and based on the determined seat and the determined current environmental conditions, an automatic door of the motor vehicle as an egress/ingress door for the passenger ingress or egress and specifying a door opening configuration for the egress/ingress door; and actuating, by a door control unit, the egress/ingress door based on the specified door opening configuration.

According to another aspect of the present disclosure, a system for selectively actuating an automatic door of a motor vehicle for passenger ingress or egress includes: a seat allocation unit configured to determine a seat occupied by a passenger within the motor vehicle; a passenger control unit configured to assess that the passenger intends to egress the motor vehicle or that another passenger wants to ingress into the motor vehicle; an environmental sensor unit configured to determine current environmental conditions around the motor vehicle, wherein the passenger control unit is further configured based on the determined seat and the determined current environmental conditions to select an automatic door of the motor vehicle as an egress/ingress door for the passenger ingress or egress and to specify a door opening configuration for the egress/ingress door; and a door control unit configured to actuate the egress/ingress door based on the specified door opening configuration.

According to yet another aspect of the present disclosure, a motor vehicle includes the system described above.

One idea of the present disclosure is to take environmental conditions and customer needs into account by operating one or several doors of the respective vehicle selectively depending on the allocated seat(s) of the passenger(s) within the vehicle and the current conditions around the vehicle. To this end, the specific seat position of each passenger is monitored and assessed by the seat allocation unit. At the same time, several sensors acquire data from the environment, which then are considered together with the information on the seat positions to decide which specific door needs to be activated and in what way in order to maximize comfort and safety for the passengers during egress of one or several of them and during ingress of another passenger.

The present disclosure may provide particular benefits for vehicles in ride-pooling scenarios, e.g. based on automated driving. In this case, the seat allocation is particularly relevant as the seats are usually not pre-allocated, which means that customers may freely choose their seats and the allocation can only be done after each passenger is seated.

The present disclosure may, however, also be relevant for other driving applications, e.g. ride hailing, taxi driving and even private driving (irrespective whether it is manual, autonomous and/or automated). In all these instances, passenger safety and comfort may be improved under adverse environmental conditions in case that one or several passengers leave the vehicle or in case that another passenger wants to enter the vehicle. Furthermore, electrical energy may be saved (e.g. due to the reduced necessity for heating or cooling of the interior after each stop).

It is understood that the term “vehicle” or “vehicular” or other similar term as used herein is inclusive of motor vehicles in general such as passenger automobiles including purpose-built vehicles (PBV), sports utility vehicles (SUV), buses, trucks, various commercial vehicles, and the like, and includes hybrid vehicles, electric vehicles, plug-in hybrid electric vehicles, hydrogen-powered vehicles and other alternative fuel vehicles (e.g., fuels derived from resources other than petroleum). As referred to herein, a hybrid vehicle is a vehicle that has two or more sources of power, for example both gasoline-powered and electric-powered vehicles.

Advantageous embodiments and improvements of the present disclosure are found in the description and claims below.

According to an embodiment of the present disclosure, the current environmental conditions may include weather conditions including rain, snow, hail and/or wind, ambient temperature and/or pollutant levels.

For example, environmental conditions of the present disclosure may include strong rain, hail and/or snow, extreme temperatures (very cold or hot), high humidity, strong winds and contamination with toxic or otherwise unhealthy substances like, for example, fine dust, smog, nitrogen oxides, ozone, exhaust gases, toxic substances and the like.

In all of these examples, it is beneficial to open the doors of the vehicle only as far as absolutely necessary to allow the egressing passenger to leave the vehicle and/or to let the ingressing passenger enter the vehicle.

According to an embodiment of the present disclosure, the automatic door may include at least two individually movable door panels. The door opening configuration may then specify actuating merely one of the door panels depending on the determined current environmental conditions.

For example, a sliding door may include two individually movable door wings/panels. In that case it may be sufficient if only one of the two wings is opened in order to allow one or several of the passengers to egress from the vehicle and/or to let an ingressing passenger enter the vehicle.

According to an embodiment of the present disclosure, the door opening configuration may specify a size of a doorway formed by the egress/ingress door when actuated and/or an opening angle of the egress/ingress door and/or of an actuated door panel of the egress/ingress door.

In the example of a door with a single panel, the opening position and thus the opening space between the door panel and the vehicle frame may be adapted accordingly, e.g. minimized as far as possible such that the passenger can still leave/enter the vehicle, but the other passengers are as slightly affected as possible. In case of a rotating door and/or door frame, an opening angle of the door may be adapted accordingly to keep the opening as small as possible and opened as briefly as possible.

In case of a door having several individually movable panels, only one or a selected sub-set of these panels may be moved accordingly to keep an opening size and/or opening angle as small as possible.

According to an embodiment of the present disclosure, the motor vehicle may include several automatic doors, one of which may be selected as an egress/ingress door based on the determined seat and depending on the determined current environmental conditions.

In some automated ride-pooling applications, several doors are provided that are usually opened and closed together at each stop. For example, a passenger cabin may include four seats in a two-by-two and face-to-face seating layout with two automatic sliding doors, one on each lateral side of the cabin. In that case, according to the present disclosure, only one of the two sliding doors may be opened, e.g. the one on the vehicle side of the egressing/ingressing passenger(s) or the one offering better environmental conditions.

According to an embodiment of the present disclosure, for egress of the passenger, depending on the determined current environmental conditions only the automated door closest to the determined seat and/or a panel of the automated door closest to the determined seat may be actuated.

Accordingly, for ingress of the other passenger, depending on the determined current environmental conditions only the automated door farthest from the determined seat and/or a panel of the automated door farthest from the determined seat may be actuated.

For example, if it is raining, under cold temperatures and/or during strong winds, only the door that is on the side of the exiting person may be opened to avoid disturbing the others, e.g. in case that several persons are sitting opposite to each other within the passenger cabin. In another example, e.g. in case of a door with two wings/panels where one passenger sits inside the vehicle next to one of the wings/panels, only the respective other wing/panel may be opened to let another passenger enter the vehicle so that the passenger sitting on the other side of the door is affected as little as possible.

The present disclosure is explained below in greater detail with reference to embodiments depicted in the drawings as appended.

### BRIEF DESCRIPTION OF THE DRAWINGS

The accompanying drawings are included to provide a further understanding of the present disclosure and are incorporated in and constitute a part of this specification. The drawings illustrate the embodiments of the present disclosure and together with the description serve to explain the principles of the inventive concept. Other embodiments of the present disclosure and many of the intended advantages of the present disclosure should be readily appreciated as they become better understood by reference to the following detailed description. The elements of the drawings are not necessarily to scale relative to each other. In the figures, like reference numerals denote like or functionally like components, unless indicated otherwise.

FIG. 1 schematically depicts a system for selectively actuating an automatic door of a motor vehicle for an egressing or ingressing passenger according to an embodiment of the disclosure.

FIGS. 2 to 6 schematically show different motor vehicles equipped with the system of FIG. 1.

FIG. 7 shows a flow diagram of a method for selectively actuating an automatic door of a motor vehicle for an egressing or ingressing passenger according to an embodiment of the disclosure.

Although specific embodiments are illustrated and described herein, it should be appreciated by those of ordinary skill in the art that a variety of alternate and/or equivalent implementations may be substituted for the specific embodiments shown and described without departing from the scope of the present disclosure. Generally, this application is intended to cover any adaptations or variations of the specific embodiments discussed herein.

### DETAILED DESCRIPTION OF THE EMBODIMENTS

FIG. 1 schematically depicts a system 10 for selectively actuating one or several automatic doors 6 of a motor vehicle 100 for one or several egressing or ingressing passengers P according to an embodiment of the present disclosure. FIGS. 2-6 schematically show different motor vehicles equipped with the system of FIG. 1. FIG. 7 shows a flow diagram of a corresponding method M for selectively actuating an automatic door 6 of a motor vehicle 100 for passenger P ingress or egress.

The present system 10 is provided to increase comfort and safety of passengers in particular in car-pooling scenarios where several passengers share one vehicle while traveling to different destinations and thus having different exit points along a route of the vehicle.

In the prior art, typically all automatic doors of a respective vehicle are opened automatically in case that one or several passengers want to exit and/or enter the vehicle. Under extreme weather conditions, however, opening the doors will leave the other passengers unprotected against adverse weather effects at least temporarily, thereby reducing their comfort and safety.

The present approach solves the above problems by opening the doors selectively depending on the seat position of the passengers inside the vehicle, e.g. the egressing passengers, and the current environmental conditions around the vehicle so that outside conditions only influence the inside of the passenger cabin as briefly and slightly as possible, as is explained below.

The motor vehicle 100 may be, for example, an electric purpose-built vehicle (PBV), e.g. automatically driven, that is used to transport several passengers to various destinations together. As mentioned, the motor vehicle 100 may be used in a ride-pooling application, wherein various passengers P are picked-up at individual locations and dropped-off at their respective destinations.

FIGS. 1-5 show example configurations, in which a passenger cabin of the vehicle 100 is furnished with four seats 5, two pairs of seats 5 facing each other along a lateral direction of the vehicle 100.

It is to be understood, however, that these embodiments are merely an example. The present disclosure can be used in various ride-pooling scenarios also with different vehicle configurations and seat layouts/numbers. Furthermore, the presently described approach can in principle also be used in other applications, e.g. for manual vehicles with one or several automatic doors.

In the embodiment of FIG. 1, the vehicle 100 has one automatic door 6. However, in other embodiments, also two or more doors 6 can be provided (FIG. 5 depicts an embodiment with two doors 6, for example).

The system 10 includes a seat allocation unit 1 configured to determine a seat 5 occupied by a passenger P within the motor vehicle 100.

More specifically, the seat allocation unit 1 may be configured to determine the seat 5 occupied by the passenger P by using one or several seat occupancy sensors 7 to detect on which seat 5 of the motor vehicle 100 the passenger P is currently sitting.

In the ride-pooling example of FIG. 1, the system 10 may allocate to each new passenger P a respective seat 5 as soon as the passenger P enters the motor vehicle 100 and sits down on one of the seats 5. In this vein, the seat allocation unit 1 may be configured to track changes in individual seat 5 occupation when a passenger P enters or leaves the motor vehicle 100. For example, as shown in FIG. 2, one passenger P may sit on the upper left seat 5 and another passenger P may be about to leave the vehicle 100 from the seat 5 on the lower right. The respective seats 5 may have been determined and allocated to the passengers P once they have entered the vehicle 100 and sat down on the respective seat 5.

The seat allocation method is essential for such a ride-pooling scenario, because in ride pooling the seats 5 are usually not pre-allocated. Instead, customers are normally allowed to freely choose their seats 5 so that an allocation of customers to seats 5 can only be done in situ.

In a simple example, the seat occupancy sensor 7 may be a seat occupancy mat that may include several sensor elements distributed across a sensing surface (e.g. on a seat surface, on the floor in front of the seat 5 and the like). When entering the vehicle 100, each passenger P may be identified (e.g. based on location and time of the pick-up, identification documents, personal electronic devices and the like). Then the seat 5 for which a seat occupancy sensor 7 provides a signal will be assigned to the respective passenger P. As soon as the passenger P exits the vehicle 100, the seat 5 will then be taken from a corresponding list of allocated seats 5.

In order to determine the respective seats 5, the seat allocation unit 1 may also use different techniques including without limitation tracking a personal electronic device of the passenger P within the motor vehicle 100, checking a seat-belt status, employing facial recognition, employing voice recognition, verifying passenger booking information and evaluating an occupation history of the motor vehicle 100.

For example, position and movement of a mobile phone, being connected as a personal electronic device to a wireless network of the vehicle 100, may be used during ingress of a passenger P to allocate a seat 5 to the specific passenger P. In another example, a camera and/or a directional microphone (both not shown) may be used to find out which seat 5 is taken by which passenger P. The required data about the passenger P such as images and speaking pattern may be taken from respective databases, booking information and/or occupation histories of the vehicle 100, which may include any relevant information about passengers P who have used vehicle 100 in the past (including pick-up and drop-off locations/times and the like).

Again referring to FIG. 1, the system further includes a passenger control unit 2 configured to assess that at least one of the passengers P intends to egress the motor vehicle 100 or that another passenger P wants to ingress into the motor vehicle 100.

Such a decision may be based, for example, on respective booking information or the like and/or an explicit exit signal triggered by one of the passengers P inside the vehicle 100, e.g. by pressing a button at the seat 5, by talking to a driver of the vehicle 100 (or to an automatic communication system of the vehicle 100), which then in turn triggers the respective signal. Similarly, a person waiting outside the vehicle 100, e.g. at a predetermined pick-up point, may trigger a respective signal.

In the embodiment of FIG. 1, the passenger control unit 2 is connected for this purpose to a passenger scheduler 8, which may be integrated as software and/or hardware in the vehicle 100. In ride-pooling, customers usually are required to provide their pick-up point and/or destination when requesting a ride, hence it can be determined in advance where each passenger P is expected to enter/exit the vehicle 100. This information may be stored and evaluated by the passenger scheduler 8.

The system 10 further includes an environmental sensor unit 3 configured to determine current environmental conditions around the motor vehicle 100. The current environmental conditions may include, for example, weather conditions including rain, snow, hail and/or wind or the like. Further aspects may be considered in addition or alternatively, e.g. ambient temperature, pollutant levels and anything else in the environment around the vehicle 100 that may affect the passengers P inside as soon as a door 6 is opened.

The passenger control unit 2 is then configured to assess the determined seat 5 and the determined current environmental conditions to select an automatic door 6 of the motor vehicle 100 as egress/ingress door 6 for the egressing or ingressing passenger P and to specify a door opening configuration for the automatic door 6. The system 10 further includes a door control unit 4 configured to actuate the egress/ingress door 6 based on the specified door opening configuration.

In the embodiment of FIG. 1, the automatic door 6 includes two individually movable door panels 6a, 6b (e.g. of a sliding or swing sliding door). In this case, the door opening configuration may specify actuating merely one of the door panels 6a, 6b depending on the determined seat 5 and current environmental conditions.

FIG. 2 shows an embodiment for this case. As can be seen in FIG. 2, the passenger P on the lower right is about to leave the vehicle 100. This may be known to the vehicle 100 and/or a driver in advance, for example, because a corresponding passenger scheduler 8 marked the current position of the vehicle 100 as the exit point of the respective passenger P. The environmental sensor unit 3 may now detect that the weather conditions outside the vehicle 100 are inconvenient, e.g. due to strong rain, due to very low or very high temperatures or due to strong wind.

Under normal conditions, both door panels 6a, 6b would be opened automatically to let the passenger P leave the vehicle 100. However, due to the detected bad weather conditions, only one of the door panels 6a is opened by the present system 10, for example the one closest to the egressing passenger P. In that vein, the other passenger P on the upper left is not affected as much by the adverse weather conditions outside the vehicle 100 as in the case that both door panels 6a, 6b would be opened.

Hence, according to the present disclosure, depending on the determined current environmental conditions only the automated door 6 closest to the seat 5 of the egressing passenger P and/or a panel 6a, 6b of the automated door 6 closest to the seat 5 of the egressing passenger P may be actuated.

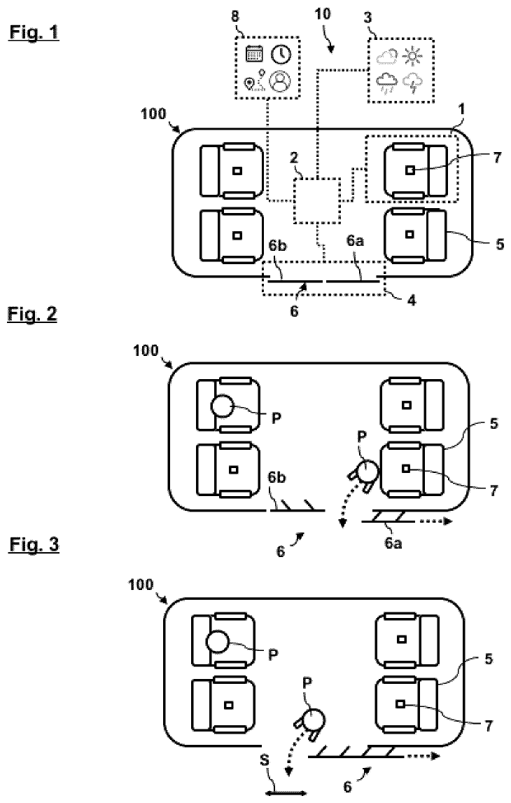

FIG. 3 shows another example. In this case, the door 6 is configured as a single sliding door 6 having only one door panel. In this case, the door opening configuration may specify a size S of a doorway formed by the egress door 6 when actuated (cf. arrow at the bottom of FIG. 3). The size S may be minimized to keep the doorway as small as possible (to protect the other passengers P) but at the same time still large enough for the passenger P to be able to pass through. The specific opening range of the door 6 may be freely adapted according to the requirements of the respective application and/or situation.

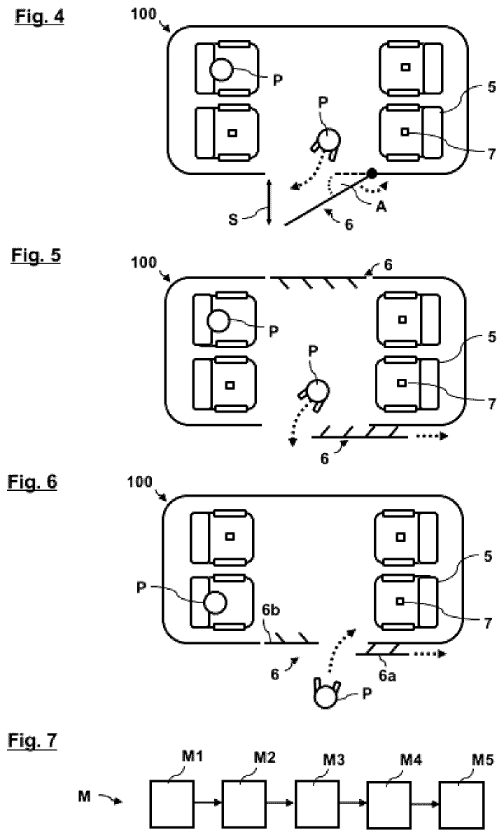

FIG. 4 is another example for a single panel door 6. In this case, the door 6 may be a single saloon door or the like, which may be rotated around a mounting axis to open up to the outside of the vehicle 100. In this case, the door opening configuration may specify an opening angle A of the egress door 6 and/or of an actuated door panel 6a, 6b of the egress door 6 (in case of a door 6 with several panels 6a, 6b).

The embodiment of FIG. 5 illustrates a case where the vehicle 100 has several doors 6, e.g. one on each lateral side. In this case, only one of both doors 6 may be opened to let out one of the passengers. In the shown example, the door 6 on the lower right is the door 6 closest to the egressing passenger P and is therefore chosen as egress door 6 to be opened. The depicted door 6 is a single sliding door 6. Hence, in addition, also the opening aperture of the door 6 may be specified, e.g. the door 6 may not be opened fully but only to a minimal opening distance large enough to let the passenger P out but small enough to protect the other passengers P as far as possible.

FIG. 6 is another example for a case with two individually movable door panels 6a, 6b similar to FIGS. 1 and 2. In this example, one passenger is sitting on the lower left seat 5 inside the vehicle 100, which is determined as before by the seat allocation unit 1. Another passenger P may want to enter the vehicle 100, e.g. at predetermined pick-up point (alternatively, the other passenger P may have also signaled to the vehicle 100 and/or the driver a request to be picked-up). In this case, only the door panel 6a on the lower right, i.e., the door panel 6a, 6b farthest from the other passenger P, may be opened to let the other passenger P into the vehicle 100 so that the passenger P already sitting in the vehicle 100 is not affected by the outside environmental conditions as much as if both panels 6a, 6b would have been opened together.

The corresponding method of FIG. 7 thus includes at step M1 determining the seats 5 occupied by the passengers P within the motor vehicle 100, at step M2 assessing that at least one of the passengers P intends to egress the motor vehicle 100 or that another passenger P wants to ingress into the motor vehicle 100, at step M3 determining the current environmental conditions around the motor vehicle 100, at step M4 selecting an automatic door 6 of the motor vehicle 100 as egress/ingress door 6 for the egressing or ingressing passenger P and specifying a door opening configuration for the egress/ingress door 6, and at step M5 actuating the egress/ingress door 6 based on the specified door opening configuration.

As a result, the present disclosure offers advantages for the operation of automatic doors in vehicles, in particular in ride-pooling scenarios. Amongst others, electrical energy may be saved and passenger comfort and protection may be improved by taking into account environmental conditions and customer needs when operating the doors to let out/in some of the passengers.

In the foregoing detailed description, various features are grouped together in one or more examples with the purpose of streamlining the disclosure. It is to be understood that the above description is intended to be illustrative, and not restrictive. It is intended to cover all alternatives, modifications and equivalents of the different features and embodiments. Many other examples should be apparent to one having ordinary skill in the art upon reviewing the above specification. The embodiments were chosen and described in order to explain the principles of the present disclosure and its practical applications, to thereby enable others having ordinary skill in the art to utilize the present disclosure and various embodiments with various modifications as are suited to the particular use contemplated.

### REFERENCE LIST

1 seat allocation unit
2 passenger control unit
3 environmental sensor unit
4 door control unit
5 seat
6 automatic door
6a, 6b door panel
7 seat occupancy sensor
8 passenger scheduler
10 system for selective door actuation
100 motor vehicle
P passenger
S size of doorway
A opening angle
M method
M1-M5 method steps

What is claimed is:

1. A method for selectively actuating an automatic door of a motor vehicle for passenger ingress or egress, the method comprising:
determining, by a seat allocation unit of the motor vehicle, a seat occupied by a passenger within the motor vehicle;
assessing, by a passenger control unit of the motor vehicle, that the passenger intends to egress the motor vehicle or that another passenger wants to ingress into the motor vehicle;
determining, by an environmental sensor unit of the motor vehicle, current environmental conditions around the motor vehicle;
selecting, by the passenger control unit and based on the determined seat and the determined current environmental conditions, an automatic door of the motor vehicle as an egress/ingress door for the passenger ingress or egress and specifying a door opening configuration for the egress/ingress door; and
actuating, by a door control unit, the egress/ingress door based on the specified door opening configuration.

2. The method according to claim 1, wherein the current environmental conditions comprise at least one of weather conditions including rain, snow, hail and/or wind, ambient temperature and pollutant levels.

3. The method according to claim 1, wherein the automatic door comprises at least two individually movable door panels, wherein the door opening configuration specifies actuating merely one of the door panels depending on the determined current environmental conditions.

4. The method according to claim 1, wherein the door opening configuration specifies a size of a doorway formed by the egress/ingress door when actuated and/or an opening angle of the egress/ingress door and/or of an actuated door panel of the egress/ingress door.

5. The method according to claim 1, wherein the motor vehicle comprises several automatic doors, one of which is selected as the egress/ingress door based on the determined seat and depending on the determined current environmental conditions.

6. The method according to claim 1, wherein, for egress of the passenger, depending on the determined current environmental conditions only the automated door closest to the determined seat and/or a panel of the automated door closest to the determined seat is actuated, or wherein, for ingress of the other passenger, depending on the determined current environmental conditions only the automated door farthest from the determined seat and/or a panel of the automated door farthest from the determined seat is actuated.

7. A system for selectively actuating an automatic door of a motor vehicle for passenger ingress or egress, the system comprising:
a seat allocation unit configured to determine a seat occupied by a passenger within the motor vehicle;
a passenger control unit configured to assess that the passenger intends to egress the motor vehicle or that another passenger wants to ingress into the motor vehicle;
an environmental sensor unit configured to determine current environmental conditions around the motor vehicle, wherein the passenger control unit is further configured based on the determined seat and the determined current environmental conditions to select an automatic door of the motor vehicle as an egress/ingress door for the passenger ingress or egress and to specify a door opening configuration for the egress/ingress door; and
a door control unit configured to actuate the egress/ingress door based on the specified door opening configuration.

8. The system according to claim 7, wherein the current environmental conditions comprise at least one of weather conditions including rain, snow, hail and/or wind, ambient temperature and pollutant levels.

9. The system according to claim 7, wherein the automatic door comprises at least two individually movable door panels, wherein the door opening configuration specifies actuating merely one of the door panels depending on the determined current environmental conditions.

10. The system according to claim 7, wherein the door opening configuration specifies a size of a doorway formed by the egress/ingress door when actuated and/or an opening angle of the egress/ingress door and/or of an actuated door panel of the egress/ingress door.

11. The system according to claim 7, wherein the motor vehicle comprises several automatic doors, one of which is selected as the egress/ingress door based on the determined seat and depending on the determined current environmental conditions.

12. The system according to claim 7, wherein, for egress of the passenger, depending on the determined current environmental conditions only the automated door closest to the determined seat and/or a panel of the automated door closest to the determined seat is actuated, or
wherein, for ingress of the other passenger, depending on the determined current environmental conditions only the automated door farthest from the determined seat and/or a panel of the automated door farthest from the determined seat is actuated.

13. A motor vehicle comprising the system according to claim 7.
